(19) United States
(12) Patent Application Publication
(10) Pub. No.: US 2024/0345513 A1
(43) Pub. Date: Oct. 17, 2024

(54) FIXING DEVICE

(71) Applicant: CANON KABUSHIKI KAISHA, Tokyo (JP)

(72) Inventors: TATSUO YASUI, Tokyo (JP); TAKUYA HASEGAWA, Tokyo (JP); KENICHI TANAKA, Ibaraki (JP); RIKIYA TAKEMASA, Chiba (JP); TOMOYUKI KURIYAMA, Tokyo (JP); AYANO SAITO, Chiba (JP); KENGO KOYAMA, Chiba (JP); SUGURU TAKEUCHI, Chiba (JP); SHUHEI YASUDA, Chiba (JP); AKIYOSHI SHINAGAWA, Saitama (JP); YASUHARU TORATANI, Chiba (JP); SHIGERU TANAKA, Tokyo (JP)

(21) Appl. No.: 18/624,476

(22) Filed: Apr. 2, 2024

(30) Foreign Application Priority Data
Apr. 12, 2023 (JP) 2023-065118

(51) Int. Cl. G03G 15/20

(52) U.S. Cl. CPC G03G 15/2017; G03G 15/2064; G03G 2215/2038

(57) ABSTRACT

A fixing device includes an endless belt, a stretching roller, a stretching member, a pressing member, a rubbing member, a moving unit configured to move the rubbing member between a first position at which the rubbing member is separated from the outer peripheral surface of the belt and a second position at which the rubbing member is in contact with the outer peripheral surface of the belt, and a steering roller. In a case where the rubbing member is located at the second position, a region of the belt rubbed by the rubbing member is sandwiched between the stretching roller and the rubbing member. In a case where the rubbing member is located at the first position, the region of the belt rubbed by the rubbing member is separated from the stretching roller and the rubbing member.

### BACKGROUND OF THE INVENTION

### Field of the Invention

The present technology relates to a fixing device suitable for use in an image forming apparatus such as a printer, a copier, a facsimile machine, or a multifunction peripheral.

### Description of the Related Art

In the image forming apparatus, an unfixed toner image is formed on a sheet-like recording material, and the toner image is heated and pressurized by a fixing device to be fixed onto the recording material. As an example of the fixing device, a so-called belt heating type fixing device using a fixing belt and a pressure roller has been proposed (JP 2012-208170 A).

In the apparatus described in JP 2012-208170 A, a heating roller is disposed in contact with an inner peripheral surface of the fixing belt, and the heating roller heated by a heater heats the fixing belt, so that heat and pressure are applied to the recording material while the recording material is conveyed in a sandwiched state in a fixing nip portion formed by the fixing belt and the pressure roller, thereby fixing the toner image onto the recording material.

Meanwhile, the surface of the fixing belt is formed of a material having good releasability such as polytetrafluoroethylene (PTFE) or a tetrafluoroethylene-perfluoroalkyl vinyl ether copolymer (PFA) in order to make it difficult for the toner melted by heat to adhere to the surface of the fixing belt. Therefore, the surface of the fixing belt is likely to be scraped by a cut end (so-called paper edge) of the recording material passing through the fixing nip portion. Then, as the scratches on the surface of the belt become deeper as the number of recording materials passing through the fixing nip portion increases, streak-like image defects occur in toner images. Therefore, as in the apparatus described in JP 2012-208170 A, hitherto, by rubbing the surface of the fixing belt using a rubbing member (also referred to as a roughening member) to roughen the surface of the fixing belt so that the scratches on the surface layer of the fixing belt are inconspicuous, an occurrence of an image defect caused by the scratches on the surface of the belt is suppressed.

In order to obtain the effect of the rubbing member, it is necessary to secure a rubbing area between the rubbing member and the fixing belt, and to bring the rubbing member into contact with the fixing belt at a predetermined contact pressure over a width direction of the fixing belt. However, hitherto, there has been a problem that a predetermined contact pressure cannot be obtained in a certain region in the width direction, and in such a case, it is difficult to obtain the effect of the rubbing member, resulting in an occurrence of an image defect.

### SUMMARY OF THE INVENTION

The present invention provides a fixing device capable of bringing a rubbing member into contact with a fixing belt at a predetermined contact pressure over a width direction.

According to one aspect of the present invention, a fixing device includes an endless belt, a stretching roller configured to stretch the belt, a stretching member configured to stretch the belt together with the stretching roller, the stretching member being disposed adjacent to the stretching roller in a rotation direction of the belt, a pressing member configured to form a nip portion by contacting the belt, the pressing member fixing a toner image onto a recording material by applying heat and pressure to the recording material bearing the toner image together with the belt, a rubbing member configured to rub an outer peripheral surface of the belt by being in contact with the outer peripheral surface of the belt between the stretching member and the stretching roller adjacent to each other in the rotation direction of the belt, a moving unit configured to move the rubbing member between a first position at which the rubbing member is separated from the outer peripheral surface of the belt and a second position at which the rubbing member is in contact with the outer peripheral surface of the belt, and a steering roller stretching the belt and configured to swing for controlling a position of the belt in a width direction of the belt. In a case where the rubbing member is located at the second position, a region of the belt rubbed by the rubbing member is sandwiched between the stretching roller and the rubbing member. In a case where the rubbing member is located at the first position, the region of the belt rubbed by the rubbing member is separated from the stretching roller and the rubbing member.

Further features of the present invention will become apparent from the following description of exemplary embodiments with reference to the attached drawings.

### BRIEF DESCRIPTION OF THE DRAWINGS

FIG. 1 is a schematic view illustrating an image forming apparatus suitable for using a fixing device according to the present embodiment.

FIG. 2 is a schematic view illustrating the fixing device according to the present embodiment.

FIG. 3A is a schematic view illustrating a position of a refresh roller when a rubbing member is at a separated position.

FIG. 3B is a schematic view illustrating a position of the refresh roller when the rubbing member is at a contact position.

FIG. 3C is a schematic view illustrating a position of the refresh roller when the rubbing member is at a rubbing position.

FIG. 4A is a schematic view illustrating a position of the refresh roller when misalignment occurs in a case where the rubbing member is at the separated position.

FIG. 4B is a schematic view illustrating a position of the refresh roller when misalignment occurs, in a case where the rubbing member is at the contact start position.

FIG. 4C is a schematic view illustrating a position of the refresh roller when misalignment occurs in a case where the rubbing member is at the rubbing position.

FIG. 5A is a schematic view illustrating a fixing device according to another embodiment.

FIG. 5B is a graph illustrating a stress applied to a fixing belt and a contact pressure in another embodiment.

FIG. 6A is a schematic view illustrating Comparative Example 1.

FIG. 6B is a graph illustrating a stress applied to a fixing belt and a contact pressure in Comparative Example 1.

FIG. 7 is a graph illustrating a comparison of a time taken for a surface roughness of the fixing belt to reach a predetermined roughness.

FIG. 8A is a schematic view illustrating a fixing device according to still another embodiment.

FIG. 8B is a graph illustrating a stress applied to a fixing belt and a contact pressure in still another embodiment.

FIG. 9A is a schematic view illustrating Comparative Example 2.

FIG. 9B is a graph illustrating a stress applied to a fixing belt and a contact pressure in Comparative Example 2.

### DESCRIPTION OF THE EMBODIMENTS

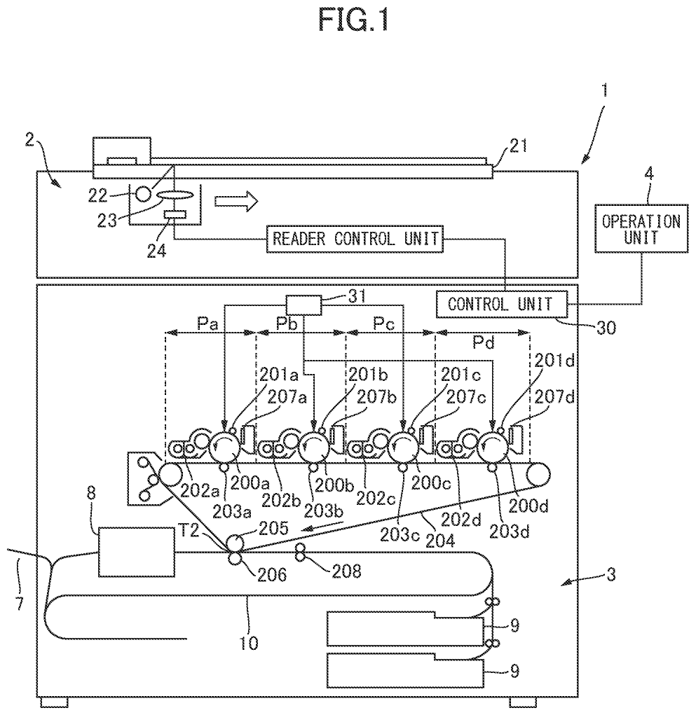

A fixing device according to the present embodiment will be described. First, a configuration of an image forming apparatus suitable for using the fixing device according to the present embodiment will be described with reference to FIG. 1.

### Image Forming Apparatus

The image forming apparatus 1 is an electrophotographic full-color printer including four image forming units Pa, Pb, Pc, and Pd provided to correspond to four colors of yellow, magenta, cyan, and black. The present embodiment is a tandem-type image forming apparatus 1 in which the image forming units Pa, Pb, Pc, and Pd are arranged along a rotation direction of an intermediate transfer belt 204 to be described below. The image forming apparatus 1 forms a toner image (image) on a recording material according to an image signal from a document reading apparatus 2 connected to an apparatus body 3 of the image forming apparatus 1 or an external host device such as a print server communicably connected to the apparatus body 3. Examples of the recording material include sheet materials such as paper, a plastic film, and cloth.

As illustrated in FIG. 1, the image forming apparatus 1 includes a document reading apparatus 2 and an apparatus body 3. The document reading apparatus 2 reads a document placed on a platen glass 21. Light emitted from a light source 22 is reflected by the document, and an image is formed on a CCD sensor 24 via an optical system member 23 such as a lens. Such an optical system unit reads the document line by line and converts the document into an electric signal data string when the document is scanned in a direction indicated by an arrow under the control of the reader control unit. The image signal obtained by the CCD sensor 24 is sent to the apparatus body 3, and a control unit 30 performs image processing in accordance with each image forming unit to be described below. The control unit 30 also receives an external input from an external host device such as a print server as an image signal.

The apparatus body 3 includes a plurality of image forming units Pa, Pb, Pc, and Pd, and each of the image forming unit forms an image based on the above-described image signal. That is, the image signal is converted into a laser beam subjected to pulse width modulation (PWM) by the control unit 30. A polygon scanner 31 serving as an exposing unit scans the laser beam corresponding to the image signal. Then, photosensitive drums 200a to 200d serving as respective image bearing members of the image forming units Pa to Pd are irradiated with a laser beam.

Note that the image forming unit Pa forms a toner image of yellow (Y), the image forming unit Pb forms a toner image of magenta (M), the image forming unit Pc forms a toner image of cyan (C), and the image forming unit Pd forms a toner image of black (Bk). Since these image forming units Pa to Pd have substantially the same configuration, the image forming unit Pa that forms a toner image of yellow (Y) will be described below as an example, and description of the other image forming units Pb to Pd will be omitted. In the image forming unit Pa, a toner image is formed on a surface of the photosensitive drum 200a based on the image signal.

A charging roller 201a charges the surface of the photosensitive drum 200a to a predetermined potential to prepare for forming an electrostatic latent image. An electrostatic latent image is formed on the surface of the photosensitive drum 200a charged to the predetermined potential by a laser beam from the polygon scanner 31. A developer 202a develops the electrostatic latent image on the photosensitive drum 200a to form a toner image. A primary transfer roller 203a performs discharging from a back surface of the intermediate transfer belt 204, applies a primary transfer bias having a polarity opposite to that of the toner, and transfers the toner image on the photosensitive drum 200a onto the intermediate transfer belt 204. After the transfer, the surface of the photosensitive drum 200a is cleaned by a cleaner 207a.

In addition, the toner image on the intermediate transfer belt 204 is conveyed to the next image forming unit, and toner images of the respective colors formed by the respective image forming units are sequentially transferred in the order of Y, M, C, and Bk, and images of four colors are formed on the surface thereof. Then, the toner image having passed through the image forming unit Pd for Bk located on the most downstream side in the rotation direction of the intermediate transfer belt 204 is conveyed to a secondary transfer unit T2 including a pair of secondary transfer rollers 205 and 206. Then, in the secondary transfer unit T2, a secondary transfer electric field having a polarity opposite to that of the toner image on the intermediate transfer belt 204 is applied, thereby secondarily transferring the toner image from the intermediate transfer belt 204 to the recording material.

The recording material is accommodated in a cassette 9, and the recording material fed from the cassette 9 is conveyed to, for example, a registration unit 208 including a pair of registration rollers, and stands by at the registration unit 208. Thereafter, the registration unit 208 conveys the recording material to the secondary transfer unit T2 at a timing controlled to align the toner images on the intermediate transfer belt 204 and the paper.

The recording material to which the toner images have been transferred by the secondary transfer unit T2 is conveyed to the fixing device 8, and the toner images are fixed to the recording material by applying heat and pressure in the fixing device 8. The recording material having passed through the fixing device 8 is discharged to a sheet discharge tray 7. Note that, in a case where images are formed on both surfaces of the recording material, when toner images are transferred and fixed to a first surface (front surface) of the recording material, the front and back surfaces of the recording material are reversed via a reverse conveyance unit 10, toner images are transferred and fixed to a second surface (back surface) of the recording material, and the recording material is discharged onto the sheet discharge tray 7.

The control unit 30 controls the entire image forming apparatus 1 as described above. Furthermore, the control unit 30 can perform various settings and the like based on inputs from an operation unit 4 included in the image forming apparatus 1. The control unit 30 includes a central processing unit (CPU), a read only memory (ROM), and a random access memory (RAM). The CPU controls each unit while reading a program corresponding to the control procedure stored in the ROM. In addition, work data and input data are stored in the RAM, and the CPU performs control with reference to the data stored in the RAM based on the above-described program or the like.

### Fixing Device

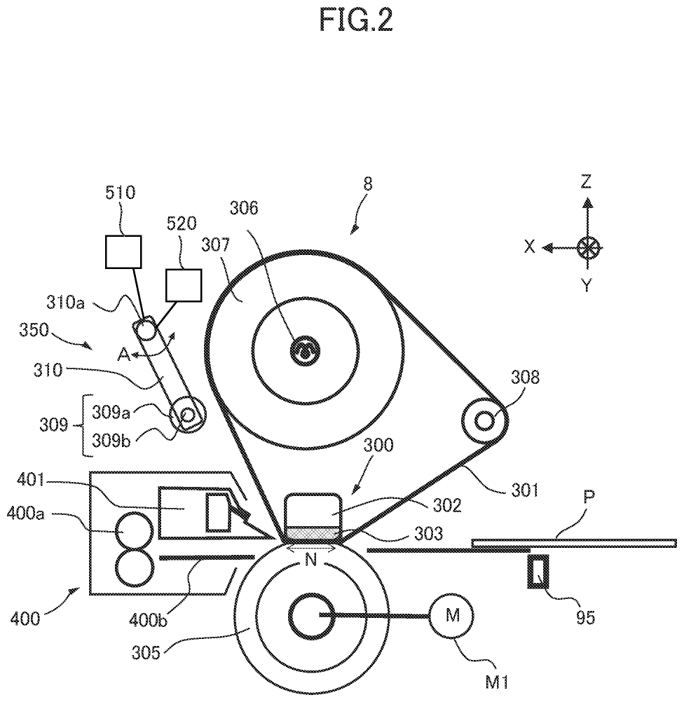

Next, the fixing device 8 according to the present embodiment will be described with reference to FIG. 2. In the present embodiment, a belt heating type fixing device 8 using an endless fixing belt 301 is adopted. As illustrated in FIG. 2, in the fixing device 8, a recording material Pis conveyed in a conveyance direction (a direction indicated by an arrow X). Note that, in the present specification, the width direction refers to a direction intersecting the conveyance direction of the recording material Pin a fixing nip portion N, in other words, a rotation axis direction of a pressure roller 305.

The fixing device 8 includes a rotating fixing belt 301, a pressure roller 305 contacting an outer peripheral surface of the fixing belt 301, a heating roller 307, a steering roller 308, a fixing pad unit 300, a rubbing member 350, and a discharge unit 400.

### Fixing Belt

The endless fixing belt 301 is stretched by the heating roller 307, the steering roller 308, and the fixing pad unit 300. The fixing belt 301 has thermal conductivity, heat resistance, and the like, and is formed in a thin cylindrical shape. The fixing belt 301 has a three-layer structure in which a base layer, an elastic layer, and a release layer are formed on a base material such as rubber in this order from the inner peripheral side. As an example, a polyimide resin (PI) having a thickness of “80 μm” is used for the base layer, a silicone rubber having a thickness of “300 μm” is used for the elastic layer, and a tetrafluoroethylene-perfluoroalkoxyethylene copolymer resin (PFA) having a thickness of “30 μm” is used for the release layer.

### Pressure Roller

The pressure roller 305 serving as a pressure rotary member is rotatably supported by a frame (not illustrated) of the fixing device 8, has one end to which a gear (not illustrated) is fixed in the width direction, and is connected to a motor M1 via the gear to be rotationally driven. When the pressure roller 305 rotates, the rotational force of the pressure roller 305 is transmitted to the fixing belt 301 by the frictional force generated in the fixing nip portion N. In this way, the fixing belt 301 is rotated following the pressure roller 305.

The pressure roller 305 is a roller having a cylindrical core metal, an elastic layer formed on an outer circumference of the core metal, and a release layer formed on the elastic layer. As an example, stainless steel (SUS) having a diameter of “72 mm” is used for the core metal, conductive silicone rubber having a thickness of “8 mm” for the elastic layer, and PFA having a thickness of “100 μm” for the release layer.

The pressure roller 305 contacts the outer peripheral surface of the fixing belt 301 in such a manner as to sandwich the fixing belt 301 between the pressure roller 305 and a pressure pad 303, and forms a fixing nip portion N in which the recording material is conveyed in the conveyance direction (in a direction indicated by an arrow X) in the sandwiched state to fix the toner image on the recording material P. To do so, the pressure roller 305 is pressurized toward the pressure pad 303 by a driving source that is not illustrated. In the present embodiment, for example, the pressure roller 305 presses the fixing belt 301 so that the pressure force at the fixing nip portion N is “1600 N”, the length of the fixing nip portion N in the conveyance direction is “24.5 mm”, and the length of the fixing nip portion N in the width direction is “326 mm”.

### Heating Roller

The heating roller 307 serving as a stretching roller is disposed inside the fixing belt 301, and is rotatably supported by the frame (not illustrated) of the fixing device 8 to stretch the fixing belt 301 together with the fixing pad unit 300. The heating roller 307 is, for example, a metal roller formed of metal such as aluminum or stainless steel having a thickness of “1 mm” in a cylindrical shape, and a halogen heater 306 serving as a heating member for heating the fixing belt 301 is disposed inside the heating roller 307. Then, the heating roller 307 is heated to a predetermined temperature by the halogen heater 306, so that the fixing belt 301 is heated by the heating roller 307.

### Fixing Pad Unit

The fixing pad unit 300 includes a stay 302 and a pressure pad 303, is disposed inside the fixing belt 301, and is attached to the frame (not illustrated) of the fixing device 8. The stay 302 is, for example, a metal rigid member extending in the width direction of the fixing belt 301, and the stay 302 supports the pressure pad 303 on the pressure roller 305 side.

In the present embodiment, the fixing belt 301 is pressed by the pressure roller 305 from the outside against the pressure pad 303 supported by the stay 302. As a result, the fixing nip portion N that is a wide nip of which a length in the conveyance direction and a length in the width direction are secured is formed between the pressure roller 305 and the fixing belt 301. Further, by supporting the pressure pad 303 made of resin on the stay 302 made of metal having higher rigidity, it is possible to reduce a deflection generated due to the pressure in the pressure pad 303 when pressurized is reduced, thereby obtaining a uniform fixing nip width in the width direction.

### Pressure Pad

The pressure pad 303 is provided inside the fixing belt 301 in a non-rotatable manner. The pressure pad 303 is a resin member extending in the width direction, and a length in the width direction of the pressure pad 303 is longer than a length in the width direction of a recording material having a maximum size in which an image can be formed. The pressure pad 303 is made of, for example, resin with good insulation and heat resistance such as liquid crystal polymer (LCP) resin. In the present embodiment, the pressure pad 303 serving as a stretching member is disposed in parallel with the heating roller 307 in the rotation direction of the fixing belt 301, and stretches the fixing belt 301 together with the heating roller 307.

In order to reduce the frictional force between the fixing belt 301 and the pressure pad 303, a sliding member (not illustrated) is preferably provided between the pressure pad 303 and the fixing belt 301. The sliding member is disposed at a position facing the pressure roller 305 with the fixing belt 301 interposed therebetween. In addition, a lubricant such as silicone oil is preferably applied to an inner peripheral surface of the fixing belt 301 in order to smoothly slide the fixing belt 301 with respect to the sliding member.

### Steering Roller

The steering roller 308 is disposed inside the fixing belt 301 between the heating roller 307 and the pressure pad 303 in the rotation direction of the fixing belt 301. The steering roller 308 has a rotation center at one end or in the vicinity of the center, rotates with respect to the fixing belt 301 to generate a tension difference, making it possible to move the fixing belt 301 in the width direction (Y direction). The steering roller 308 is, for example, a hollow metal shaft (e.g., a stainless steel shaft) formed to be hollow and have a diameter “φ20 mm”. In order to increase the grip force with respect to the fixing belt 301, a rubber material or the like may be provided on the surface of the metal shaft. Although the example in which the steering roller 308 is provided has been described here, the present technology is not limited thereto. The steering roller 308 may not be provided, and another stretching roller may be provided instead of the steering roller 308.

### Discharge Unit

A discharge unit 400 for discharging the recording material P having passed through the fixing nip portion N from the fixing device 8 is disposed downstream of the fixing nip portion N in the conveyance direction. The discharge unit 400 includes an air nozzle 401 that blows, to the recording material P, compressed air for separating the recording material P after passing through the fixing nip portion N from the fixing belt 301, a lower separation guide 400b for separating the recording material P from the pressure roller 305, and a conveyance roller pair 400a for conveying the separated recording material P to be discharged from the fixing device 8 to the outside. The conveyance roller pair 400a is disposed at a position separated from the fixing nip portion N by, for example, “40 mm” on the downstream side in the conveyance direction. Note that a recording material detection sensor 95 for detecting a timing at which the recording material Penters the fixing device 8 may be disposed upstream of the fixing nip portion N in the conveyance direction.

### Rubbing Member

In order to reduce the influence of scratches generated on the surface (outer peripheral surface) of the fixing belt 301 by the paper edge of the recording material P passing through the fixing nip portion N, the fixing device 8 includes a rubbing member 350 for rubbing the surface (outer peripheral surface) of the fixing belt 301 to make the surface roughness Sa (arithmetic average height) of the fixing belt 301 uniform. The rubbing member 350 includes a refresh roller 309 and a support 310 that rotatably supports the refresh roller 309.

The refresh roller 309 serving as a roughening roller includes a rubbing portion 309a that rubs the surface of the fixing belt 301 and supported portions 309b provided at both ends of the rubbing portion 309a in the width direction. The rubbing portion 309a and the supported portions 309b are formed in a cylindrical shape with their axial center positions are coaxial, and the rubbing portion 309a has a larger diameter than the supported portions 309b. In the rubbing portion 309a, a rubbing layer in which irregularities are formed is provided by densely adhering abrasive grains serving as a rubbing material, via an adhesive layer, onto a stainless steel core metal having an outer diameter of, for example, “12 mm”. In the present embodiment, white alundum (WA) having an average particle diameter of “about 12 μm” was used as the rubbing material. As another example of the rubbing material, abrasive grains formed of any of aluminum oxide, aluminum hydroxide oxide, silicon oxide, and a mixture thereof having an average particle size of “5 μm or more and 20 μm or less” may be adhered with an adhesive layer.

The supported portion 309b is, for example, a stainless steel core metal having an outer shape of “6 mm”. A gear is fixed to one end side of the supported portion 309b, and a rotational driving force is transmitted by a driving unit 520 including a motor, a gear, and the like. The refresh roller 309 is rotated by the driving unit 520 at a speed different from the rotational speed of the fixing belt 301 and in a direction opposite to the rotation direction of the fixing belt 301.

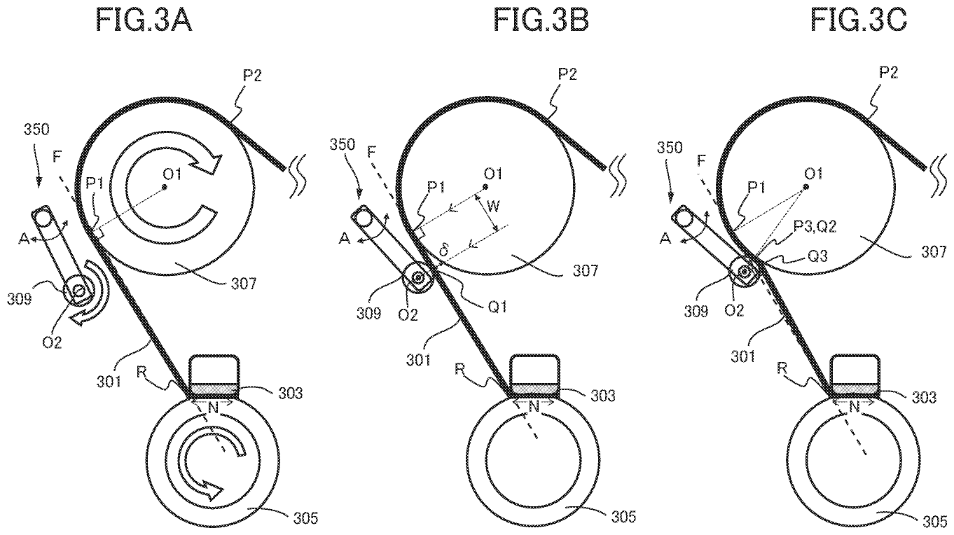

The rubbing member 350 is provided to be movable between a rubbing position (see FIG. 3C as will be described below) at which the refresh roller 309 rubs the fixing belt 301 and a separated position (see FIG. 3A as will be described below) at which the refresh roller 309 is separated from the fixing belt 301. When the rubbing member 350 is at the rubbing position, the refresh roller 309 rubs the fixing belt 301 to roughen the surface of the fixing belt 301. At this time, when the contact pressure against the fixing belt 301 is, for example, “60 N”, the refresh roller 309 can efficiently roughen the surface of the fixing belt 301.

The support 310 serving as a support member is supported by the frame (not illustrated) of the fixing device 8 so as to be swingable in a direction indicated by an arrow A around a swing center axis 310a. When the support 310 is swung by a moving unit 510 including a motor, a gear, and the like, the rubbing member 350 can move between the rubbing position (second position) and the separated position (first position).

### Position of Refresh Roller

In the present embodiment, when the rubbing member 350 is at the rubbing position, the refresh roller 309 can come into contact with the fixing belt 301 at a predetermined contact pressure (e.g., 60 N) over the width direction. Hereinafter, a configuration according to the present embodiment for realizing this will be described with reference to FIGS. 3A to 3C.

FIG. 3A illustrates a position of the refresh roller 309 when the rubbing member 350 is at a separated position, FIG. 3B illustrates a position of the refresh roller 309 when the rubbing member 350 is at a contact start position, and FIG. 3C illustrates a position of the refresh roller 309 when the rubbing member 350 is at a rubbing position. When the rubbing member 350 is swung in the A direction, the refresh roller 309 moves to the position illustrated in one of FIGS. 3A to 3C.

As illustrated in FIG. 3A, when the rubbing member 350 is at the separated position, the fixing belt 301 is wound around the heating roller 307 to be in contact with the heating roller 307 in an arc shape connecting a point P1 and a point P2 to each other. The point P1 is a position of an upstream end in the rotation direction in the contact range where the heating roller 307 and the fixing belt 301 are in contact with each other. The point P2 is a position of a downstream end in the rotation direction in the contact range where the heating roller 307 and the fixing belt 301 are in contact with each other.

When the rubbing member 350 is at the separated position, the fixing belt 301 moves between the pressure pad 303 and the heating roller 307 along a tangent line F. That is, the fixing belt 301 moves on a straight line P1-R that substantially coincides with the tangent line F passing through the point P1 among tangents on the circumferential surface of the heating roller 307 contacting the fixing belt 301. The point R is a position of a downstream end in the rotation direction in the contact range where the pressure pad 303 and the fixing belt 301 are in contact with each other. Note that a point O1 in the drawing is a rotation center of the heating roller 307, and a point O2 in the drawing is a rotation center of the refresh roller 309.

Until the rubbing member 350 moves from the separated position to the contact start position where the contact with the fixing belt 301 is started, the fixing belt 301 moves on the straight line P1-R in contact with the heating roller 307 along the arc P1-P2. When the rubbing member 350 moves to the contact start position, the refresh roller 309 starts to contact the fixing belt 301 at a position of a point Q1 as illustrated in FIG. 3B. In the present embodiment, the point Q1 is a position where a distance (referred to as an initial shift amount) from the point P1 in the straight line P1-R is “W”. When the refresh roller 309 starts to contact the fixing belt 301, the fixing belt 301 is not in contact with the heating roller 307 at the point Q1, and a movement space 8 for further moving the refresh roller 309 toward the heating roller 307 is secured.

When the rubbing member 350 moves to the rubbing position, the refresh roller 309 is stretched between the heating roller 307 and the pressure pad 303 as illustrated in FIG. 3C. When the rubbing member 350 is at the separated position, the rubbing member 350 presses a part of the fixing belt 301 that is away from the heating roller 307 to come into contact with the heating roller 307. That is, the refresh roller 309 abuts against the heating roller 307 with the fixing belt 301 interposed therebetween. In the present embodiment, the refresh roller 309 starts to come into contact with the fixing belt 301 that is away from the heating roller 307 when the rubbing member 350 is at the separated position at a position where the “initial shift amount is W>0”, and then the fixing belt 301 is pushed until the movement space 8 becomes “0”. In other words, the refresh roller 309 presses the fixing belt 301 inward of the tangent line F passing through the point P1 toward the heating roller 307 to press the fixing belt 301 against the heating roller 307. That is, in a case where the rubbing member 350 is located at the second position, the region of the belt 301 rubbed by the rubbing member 350 is located on a side of the stretching roller 307 across the common external tangent line F.

By doing so, the fixing belt 301 moves on a straight line Q3-R in contact with the heating roller 307 along an arc P3-P2 that is longer than the arc P1-P2. The straight line Q3-R is located inside the straight line P1-R that substantially coincides with the tangent line F passing through the point P1. The point P3 is a position of an upstream end in the rotation direction in the contact range where the heating roller 307 and the fixing belt 301 are in contact with each other when the rubbing member 350 is at the rubbing position. The point Q3 is a position of an upstream end in the rotation direction in the contact range where the refresh roller 309 and the fixing belt 301 are in contact with each other when the rubbing member 350 is at the rubbing position. In this way, by pressing the fixing belt 301 against the heating roller 307 in contact with the fixing belt 301 at the position of the point Q1, an arc Q2-Q3, which is region where the refresh roller 309 is in contact with the fixing belt 301, can be secured in the refresh roller 309, and a predetermined contact pressure can be obtained over the width direction.

### Effect for Misalignment

Meanwhile, in the fixing device 8, alignment (parallelism) between the fixing belt 301 and the pressure pad 303 or the pressure roller 305 needs to be kept constant so that the recording material nipped while being conveyed in the fixing nip portion N does not skew. However, in the fixing device 8, alignment (parallelism) between the fixing belt 301 and the pressure pad 303 or the pressure roller 305 may not be kept constant (referred to as misalignment). When misalignment occurs, there is a possibility that the fixing belt 301 may be deviated to either end in the width direction during rotation (so-called belt deviation). In order to correct the belt deviation, in the present embodiment, a steering roller 308 that controls the position of the fixing belt 301 in the width direction is disposed (see FIG. 2).

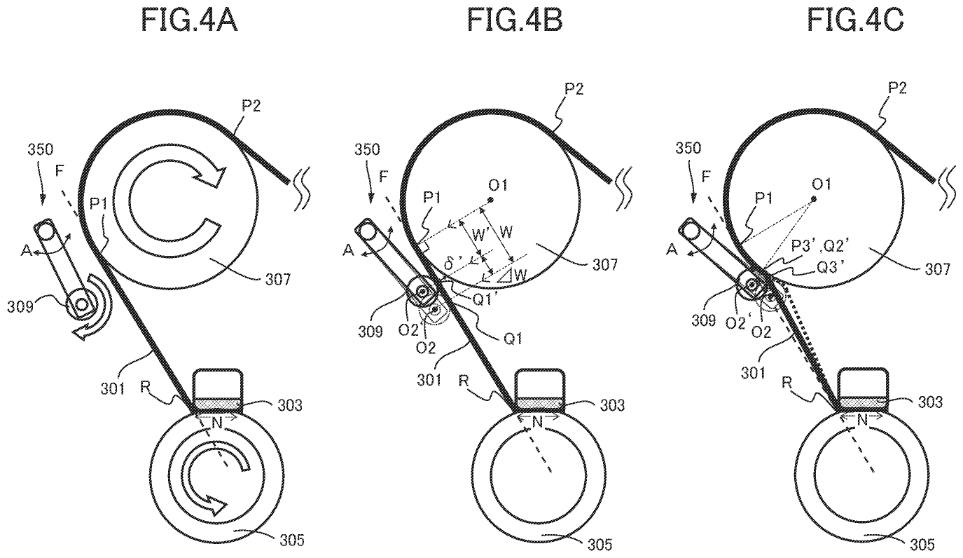

In the present embodiment, even if misalignment occurs, when the rubbing member 350 is at the rubbing position, the refresh roller 309 can come into contact with the fixing belt 301 at a predetermined contact pressure over the width direction. This point will be described below with reference to FIGS. 4A to 4C. Concerning the fixing device 8 in which misalignment occurs, FIG. 4A illustrates a position of the refresh roller 309 when the rubbing member 350 is at a separated position, FIG. 4B illustrates a position of the refresh roller 309 when the rubbing member 350 is at a contact start position, and FIG. 4C illustrates a position of the refresh roller 309 when the rubbing member 350 is at a rubbing position. Here, a case where one end side of the heating roller 307 in the width direction is inclined toward the pressure pad 303 relative to the other end side of the heating roller 307 in the width direction as the misalignment will be described as an example.

As illustrated in FIG. 4A, even if misalignment occurs, when the rubbing member 350 is at the separated position, the fixing belt 301 is wound around the heating roller 307 to be in contact with the heating roller 307 in an arc shape connecting a point P1 and a point P2 to each other. In addition, the fixing belt 301 moves on a straight line P1-R that substantially coincides with the tangent line F passing through the point P1 among tangents on the circumferential surface of the heating roller 307 contacting the fixing belt 301.

When the rubbing member 350 moves to the contact start position, the refresh roller 309 starts to contact the fixing belt 301 at a position of a point Q1′, on one end side of the heating roller 307 inclined toward the pressure pad 303 (at a position of a point Q1 is located the other end side of the heating roller 307), as illustrated in FIG. 4B. The position of the point Q1′ is closer to the heating roller 307 by “ΔW” than the position of the point Q1 on the other end side, and the position of the point Q1′ is proportional to an amount of difference (referred to as a misalignment amount ΔW) between one end and the other end of the heating roller 307.

When the refresh roller 309 starts to contact the fixing belt 301, the fixing belt 301 is not in contact with the heating roller 307 at the point Q1′, and a movement space δ′ for further moving the refresh roller 309 toward the heating roller 307 is secured. When the initial shift amount on the other end side is “W(>ΔW)”, the initial shift amount on the one end side is “W’>0(=W−ΔW)”, and the movement space is “δ>”.

Although the movement space δ′ is shorter than the movement space 8 on the other end side, the presence of the movement space δ′ allows the refresh roller 309 to be stretched between the heating roller 307 and the pressure pad 303 and to press a part of the fixing belt 301, which is away from the heating roller 307 when the rubbing member 350 is at the separated position, to come into contact with the heating roller 307, as illustrated in FIG. 4C. The refresh roller 309 presses the fixing belt 301 until the movement space δ′ becomes “0” on one end side and until the movement space 8 becomes “0” on the other end side. Thus, even if misalignment occurs, the refresh roller 309 can press the fixing belt 301 at both ends inward of the tangent line F passing through the point P1 toward the heating roller 307 to press the fixing belt 301 against the heating roller 307.

In this way, as the refresh roller 309 pressing the fixing belt 301 against the heating roller 307 on the one end side in contact with the fixing belt 301 at the position of the point Q1′, an arc Q2′-Q3′, which is region where the refresh roller 309 is in contact with the fixing belt 301, can also be secured on the one end side of the refresh roller 309, thereby obtaining a predetermined contact pressure over the width direction. By setting an initial shift amount W′ to be larger than the misalignment amount ΔW, it is possible to obtain a desired contact pressure over the entire region of the refresh roller 309 in the width direction.

As described above, in the present embodiment, the refresh roller 309 is stretched between the heating roller 307 and the pressure pad 303, and presses a part of the fixing belt 301, which is away from the heating roller 307 when the rubbing member 350 is at the separated position, to come into contact with the heating roller 307. That is, when the rubbing member 350 is at the rubbing position, the refresh roller 309 abuts against the heating roller 307 with the fixing belt 301 interposed therebetween. At this time, the refresh roller 309 presses the fixing belt 301 inward of the tangent line F passing through the point P1 toward the heating roller 307 to press the fixing belt 301 against the heating roller 307. In this way, by pressing the fixing belt 301 against the heating roller 307 in contact with the fixing belt 301, an arc Q2-Q3, which is region where the refresh roller 309 is in contact with the fixing belt 301, can be secured in the refresh roller 309, and a predetermined contact pressure can be obtained over the width direction.

### Other Embodiments

In the present embodiment described above, the refresh roller 309 presses a part of the fixing belt 301, downstream of the pressure pad 303 and upstream of the heating roller 307 in the rotation direction of the fixing belt 301, to come into contact with the heating roller 307, but the present technology is not limited thereto. For example, the refresh roller 309 may press a part of the fixing belt 301, upstream of the pressure pad 303 and downstream of the heating roller 307 in the rotation direction of the fixing belt 301, to come into contact with the heating roller 307. The steering roller 308 may not be provided, or another stretching roller may be provided instead of the steering roller 308.

It is preferable that the refresh roller 309 may press a part of the fixing belt 301, downstream of the pressure pad 303 and upstream of the heating roller 307 in the rotation direction of the fixing belt 301, to come into contact with the heating roller 307. This is to suppress the excessive scraping of the surface of the fixing belt 301 by roughening the surface of the fixing belt 301 using the refresh roller 309 before the fixing belt 301 is heated by the heating roller 307 and the temperature of the fixing belt 301 is increased, taking into account that the increase in temperature of the fixing belt 301 causes the surface of the fixing belt 301 to be soft and easy to scrape.

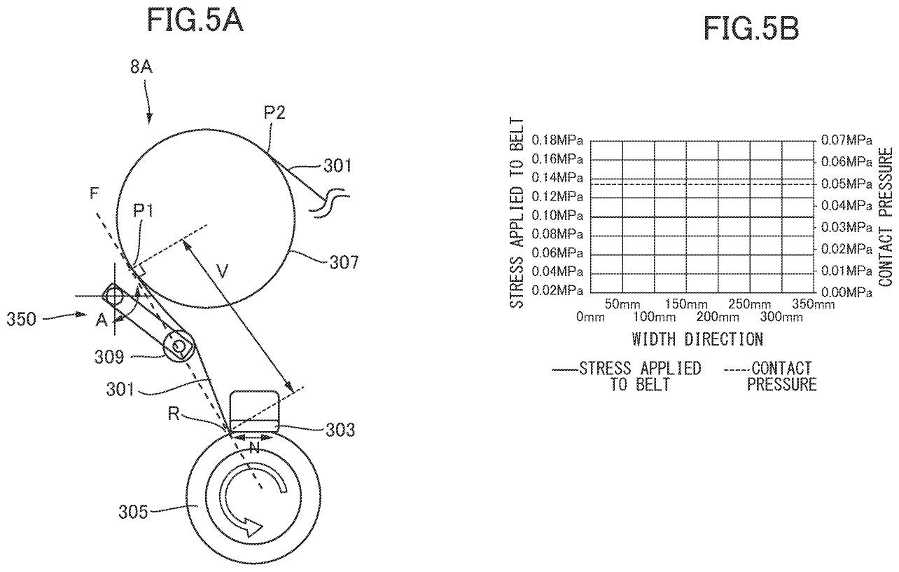

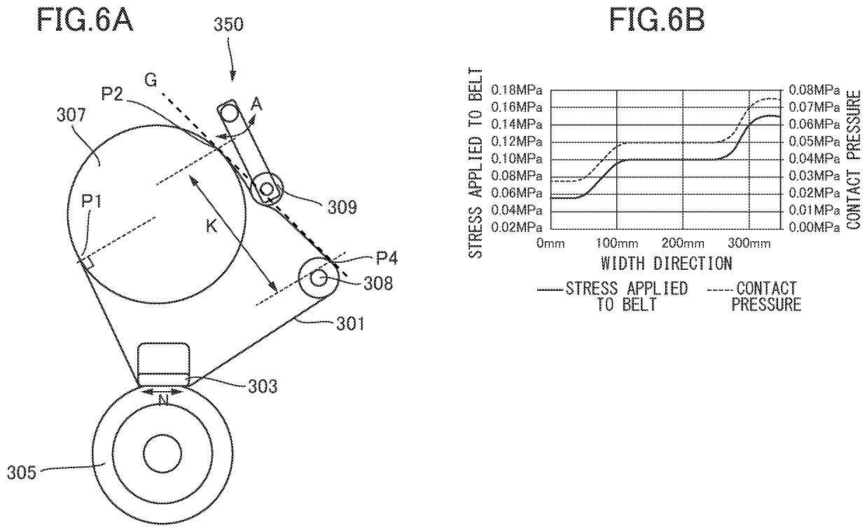

Next, a fixing device according to another embodiment will be described with reference to FIGS. 5A to 7. FIG. 5A is a schematic view illustrating a fixing device 8A, and FIG. 5B is a graph illustrating a stress applied to the fixing belt 301 and a contact pressure in the fixing device 8A. FIG. 6A is a schematic diagram illustrating Comparative Example 1, and FIG. 6B is a graph illustrating a stress applied to a fixing belt and a contact pressure in Comparative Example 1. Here, the components that are the same as those of the fixing device 8 described above will be denoted by the same reference signs.

In the fixing device 8A illustrated in FIG. 5A, when the rubbing member 350 is at the contact start position, the position at which the refresh roller 309 comes into contact with the fixing belt 301 is in a “region V” on the straight line P1-R that substantially coincides with the tangent line F passing through the point P1 among tangents of the circumferential surface of the heating roller 307 contacting the fixing belt 301. That is, the refresh roller 309 comes into contact with the fixing belt 301 downstream of the pressure pad 303 and upstream of the heating roller 307 in the rotation direction of the fixing belt 301. However, when the rubbing member 350 is at the rubbing position, the refresh roller 309 is positioned not to abut against the heating roller 307 with the fixing belt 301 interposed therebetween as illustrated in FIG. 5A. In this case, the fixing belt 301 is in contact with the heating roller 307 along the arc P1-P2.

As described above, when the refresh roller 309 is brought into contact with the fixing belt 301 downstream of the pressure pad 303 and upstream of the heating roller 307 in the rotation direction of the fixing belt 301, even if the steering roller 308 rotates with respect to the fixing belt 301 and a stress difference occurs in the width direction of the fixing belt 301, the fixing belt 301 is hardly affected by the stress difference. Therefore, as illustrated in FIG. 5B, the refresh roller 309 is brought into contact with fixing belt 301 at a contact pressure (0.05 MPa) uniform in the width direction.

On the other hand, in Comparative Example 1 illustrated in FIG. 6A, when the rubbing member 350 is at the contact start position, the position at which the refresh roller 309 comes into contact with the fixing belt 301 is in a “region K” on a straight line P2-P4 that substantially coincides with a tangent line G passing through the point P2 among tangents of the circumferential surface of the heating roller 307 contacting the fixing belt 301. The point P4 is a position on an upstream end in the rotation direction in the contact range where the steering roller 308 and the fixing belt 301 are in contact with each other. That is, the refresh roller 309 comes into contact with the fixing belt 301 downstream of the heating roller 307 and upstream of the steering roller 308 in the rotation direction of the fixing belt 301. However, when the rubbing member 350 is at the rubbing position, the refresh roller 309 is positioned not to abut against the heating roller 307 with the fixing belt 301 interposed therebetween as illustrated in FIG. 6A. In this case, the fixing belt 301 is in contact with the heating roller 307 along the arc P1-P2.

However, in Comparative Example 1, when the steering roller 308 rotates with respect to the fixing belt 301 and a stress difference occurs in the width direction of the fixing belt 301, since the contact pressure between the refresh roller 309 and the fixing belt 301 varies in the width direction as illustrated in FIG. 6B, there may be a portion where the predetermined contact pressure (0.05 MPa) cannot be obtained. In this case, in order for the fixing belt 301 to have a predetermined surface roughness over the entire region thereof in the width direction of the fixing belt 301, it is necessary to bring the refresh roller 309 into contact with the fixing belt 301 for a time required to make a surface roughness of a portion where the contact pressure is small to be a predetermined surface roughness.

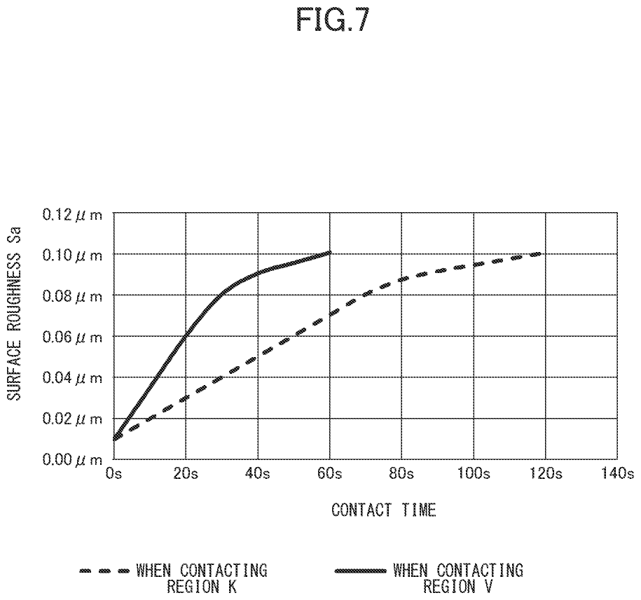

FIG. 7 is a graph illustrating a comparison of a time taken for the surface roughness of the fixing belt 301 to reach a predetermined roughness (for example, 0.1 μm) between a case where the refresh roller 309 is in contact with a “region K” and a case where the refresh roller 309 is in contact with a “region V”. As illustrated in FIG. 7, the contact time for which the refresh roller 309 is in contact with the fixing belt 301 is longer in Comparative Example 1 in which the refresh roller 309 is in contact with the “region K” than in the fixing device 8A in which the refresh roller 309 is in contact with the “region V”. This is because, as described above, the contact time for which the refresh roller 309 is in contact with the fixing belt 301 is a time required for a surface roughness of a portion having a small contact pressure to reach the predetermined surface roughness. Here, to change the surface roughness Sa of the fixing belt 301 from “0.01 μm” to “0.1 μm”, “60 s” is required in the fixing device 8A, and “120 s” is required in Comparative Example 1.

Thus, the time for which the refresh roller 309 is in contact with the fixing belt 301 can be shortened only by bringing the refresh roller 309 into contact with the “region V” rather than the “region K”. Therefore, it is preferable that the refresh roller 309 is in contact with the fixing belt 301 in the “region V”, that is, downstream of the heating roller 307 and upstream of the steering roller 308 in the rotation direction of the fixing belt 301.

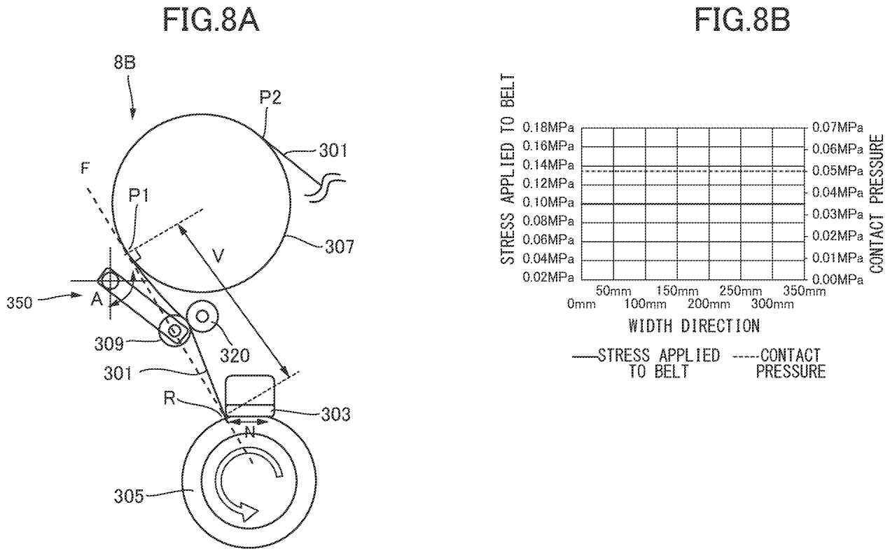

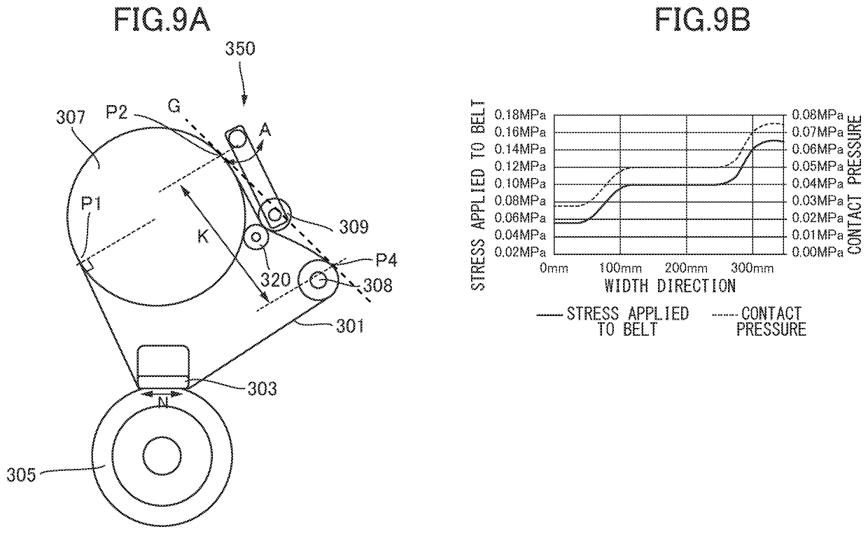

Next, a fixing device according to still another embodiment will be described with reference to FIGS. 8A to 9B. FIG. 8A is a schematic view illustrating a fixing device 8B, and FIG. 8B is a graph illustrating a stress applied to the fixing belt 301 and a contact pressure in the fixing device 8B. FIG. 9A is a schematic diagram illustrating Comparative Example 2, and FIG. 9B is a graph illustrating a stress applied to the fixing belt 301 and a contact pressure in Comparative Example 2. Here, the components that are the same as those of the fixing device 8 described above will be denoted by the same reference signs.

The fixing device 8B illustrated in FIG. 8A includes a backup member 320, and the backup member 320 is disposed inside the fixing belt 301 at a position where the fixing belt 301 is sandwiched between the refresh roller 309 and the backup member 320. The backup member 320 is, for example, a roller in which an elastic layer of silicone rubber having a thickness of 5 mm is formed on a stainless steel core metal having an outer diameter of 5 mm via an adhesive layer.

The backup member 320 slides on the fixing belt 301 when the rubbing member 350 is at the rubbing position, and does not slide on the fixing belt 301 when the rubbing member 350 is at the separated position.

That is, the backup member 320 is fixedly disposed inside the fixing belt 301 to sandwich the fixing belt 301 between the refresh roller 309 and the backup member 320 when the rubbing member 350 is at the rubbing position. When the refresh roller 309 comes into contact with the fixing belt 301, the fixing belt 301 is pressed toward the backup member 320, and the inner peripheral surface of the fixing belt 301 is brought into contact with the backup member 320. As a result, the operation of roughening the belt surface by the refresh roller 309 can be appropriately performed. In addition, the backup member 320 is disposed to form a gap with the inner peripheral surface of the fixing belt 301 when the rubbing member 350 is at the separated position.

When the rubbing member 350 is at the contact start position, the position at which the refresh roller 309 comes into contact with the fixing belt 301 is in a “region V” on the straight line P1-R that substantially coincides with the tangent line F passing through the point P1 among tangents of the circumferential surface of the heating roller 307 contacting the fixing belt 301. That is, the refresh roller 309 comes into contact with the fixing belt 301 downstream of the pressure pad 303 and upstream of the heating roller 307 in the rotation direction of the fixing belt 301. In the fixing device 8B, when the rubbing member 350 is at the rubbing position, as illustrated in FIG. 8A, the refresh roller 309 abuts against the backup member 320 with the fixing belt 301 interposed therebetween, and thus does not abut against the heating roller 307. In this case, the fixing belt 301 is in contact with the heating roller 307 along the arc P1-P2.

As described above, when the refresh roller 309 is brought into contact with the fixing belt 301 downstream of the pressure pad 303 and upstream of the heating roller 307 in the rotation direction of the fixing belt 301, even if the steering roller 308 rotates with respect to the fixing belt 301 and a stress difference occurs in the width direction of the fixing belt 301, the fixing belt 301 is hardly affected by the stress difference. Therefore, as illustrated in FIG. 8B, the refresh roller 309 is brought into contact with fixing belt 301 at a contact pressure (0.05 MPa) uniform in the width direction.

On the other hand, in Comparative Example 2 illustrated in FIG. 9A, a backup member 320 is included, the backup member 320 being disposed inside the fixing belt 301 at a position where the fixing belt 301 is sandwiched between the refresh roller 309 and the backup member 320. However, in Comparative Example 2, when the rubbing member 350 is at the contact start position, the position at which the refresh roller 309 comes into contact with the fixing belt 301 is in a “region K” on a straight line P2-P4 that substantially coincides with a tangent line G passing through the point P2 among tangents of the circumferential surface of the heating roller 307 contacting the fixing belt 301. That is, the refresh roller 309 comes into contact with the fixing belt 301 downstream of the heating roller 307 and upstream of the steering roller 308 in the rotation direction of the fixing belt 301. In Comparative Example 2, when the rubbing member 350 is at the rubbing position, as illustrated in FIG. 9A, the refresh roller 309 abuts against the backup member 320 with the fixing belt 301 interposed therebetween, and thus does not abut against the heating roller 307. In this case, the fixing belt 301 is in contact with the heating roller 307 along the arc P1-P2.

However, in Comparative Example 2, when the steering roller 308 rotates with respect to the fixing belt 301 and a stress difference occurs in the width direction of the fixing belt 301, since the contact pressure between the refresh roller 309 and the fixing belt 301 varies in the width direction as illustrated in FIG. 9B, there may be a portion where the predetermined contact pressure (0.05 MPa) cannot be obtained. In this case, in order for the fixing belt 301 to have a predetermined surface roughness over the entire region thereof in the width direction of the fixing belt 301, it is necessary to bring the refresh roller 309 into contact with the fixing belt 301 for a time required to make a surface roughness of a portion where the contact pressure is small to be a predetermined surface roughness.

Even in the case where backup member 320 is provided, as illustrated in FIG. 7 described above, the contact time for which the refresh roller 309 is in contact with the fixing belt 301 is longer in Comparative Example 2 in which the refresh roller 309 is in contact with the “region K” than in the fixing device 8B in which the refresh roller 309 is in contact with the “region V”. So, the time for which the refresh roller 309 is in contact with the fixing belt 301 can be shortened only by bringing the refresh roller 309 into contact with the “region V” rather than the “region K”. Therefore, it is preferable that the refresh roller 309 is in contact with the fixing belt 301 in the “region V”, that is, downstream of the heating roller 307 and upstream of the steering roller 308 in the rotation direction of the fixing belt 301.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2023-065118, filed Apr. 12, 2023, which is hereby incorporated by reference herein in its entirety.

What is claimed is:

1. A fixing device comprising:
an endless belt;
a stretching roller configured to stretch the belt;
a stretching member configured to stretch the belt together with the stretching roller, the stretching member being disposed adjacent to the stretching roller in a rotation direction of the belt;
a pressing member configured to form a nip portion by contacting the belt, the pressing member fixing a toner image onto a recording material by applying heat and pressure to the recording material bearing the toner image together with the belt;
a rubbing member configured to rub an outer peripheral surface of the belt by being in contact with the outer peripheral surface of the belt between the stretching member and the stretching roller adjacent to each other in the rotation direction of the belt;
a moving unit configured to move the rubbing member between a first position at which the rubbing member is separated from the outer peripheral surface of the belt and a second position at which the rubbing member is in contact with the outer peripheral surface of the belt; and
a steering roller stretching the belt and configured to swing for controlling a position of the belt in a width direction of the belt,
wherein in a case where the rubbing member is located at the second position, a region of the belt rubbed by the rubbing member is sandwiched between the stretching roller and the rubbing member, and
in a case where the rubbing member is located at the first position, the region of the belt rubbed by the rubbing member is separated from the stretching roller and the rubbing member.

2. The fixing device according to claim 1, wherein
in a case where the rubbing member is located at the second position, the region is located on a side of the stretching roller across a common external tangent line between the stretching member and the stretching roller adjacent to each other.

3. The fixing device according to claim 1, wherein
the rubbing member includes a roughening roller configured to roughen the outer peripheral surface of the belt by being in contact with the outer peripheral surface of the belt, and a support member configured to rotatably support the roughening roller, and
the moving unit is configured to move the roughening roller between the first position and the second position by swinging the support member.

4. The fixing device according to claim 3, further comprising:
a driving unit configured to rotationally drive the roughening roller.

5. The fixing device according to claim 4, wherein
the driving unit is configured to rotate the rubbing member in such a manner that a contact region where the rubbing member located at the second position is in contact with the belt moves in a direction opposite to the rotation direction of the belt.

6. The fixing device according to claim 1, further comprising:
a heating member configured to heat the stretching roller,
wherein the belt is heated via the stretching roller heated by the heating member.

7. The fixing device according to claim 1, wherein
the stretching roller is a metal roller.
